(19) United States
(12) Patent Application Publication
(10) Pub. No.: US 2024/0393707 A1
(43) Pub. Date: Nov. 28, 2024

(54) TONER, TONER ACCOMMODATING UNIT, IMAGE FORMING APPARATUS, AND IMAGE FORMING METHOD

(71) Applicants: Kei Niwayama, Shizuoka (JP); Masayuki Ishii, Shizuoka (JP); Saori Yamada, Shizuoka (JP); Shimpei Miyata, Shizuoka (JP)

(72) Inventors: Kei Niwayama, Shizuoka (JP); Masayuki Ishii, Shizuoka (JP); Saori Yamada, Shizuoka (JP); Shimpei Miyata, Shizuoka (JP)

(73) Assignee: Ricoh Company, Ltd., Tokyo (JP)

(21) Appl. No.: 18/664,523

(22) Filed: May 15, 2024

(30) Foreign Application Priority Data
May 22, 2023 (JP) 2023-083928

(51) Int. Cl. G03G 9/08; G03G 15/08

(52) U.S. Cl. CPC G03G 9/0827; G03G 15/0865

(57) ABSTRACT

A toner contains toner base particles, each containing a binder resin, a release agent, and a charge control agent, and an external additive, wherein the toner base particles have an average circularity of from 0.850 to 0.950, and the external additive contains at least an inorganic particle selected from the group consisting of barium sulfate, magnesium hydroxide, and magnesium oxide, each having an average circularity of from 350 to 1,000 nm.

### CROSS-REFERENCE TO RELATED APPLICATIONS

This patent application is based on and claims priority pursuant to 35 U.S.C. § 119 to Japanese Patent Application No. 2023-083928, filed on May 22, 2023, in the Japan Patent Office, the entire disclosure of which is hereby incorporated by reference herein.

### BACKGROUND

### Technical Field

The present disclosure relates to a toner, a toner accommodating unit, an image forming apparatus, and an image forming method.

### Description of the Related Art

In conventional electrophotographic toners, it is well known that using external additives with an average primary particle diameter of several to several tens of nanometers can impart fluidity and charging properties to the toner. Recently, in response to the diversification of uses, increased speed, and improved image quality in image forming apparatuses, the development of toners with smaller particle sizes and more spherical shapes has been advanced. The reduction in particle size of the toner improves the reproducibility of each image segment (dot), and the spherization of the toner aims to enhance developability and transferability.

Colorants, charge control agents, and release agents in the toner must be uniformly dispersed in thermoplastic resin. If dispersion is inadequate, during the pulverization process, the colorants, charge control agents, and release agents added to the toner may create fracture interfaces, resulting in the formation of abnormally shaped toner particles with low average circularity in the ultrafine powder region of 3 or less μm. Additionally, at the individual particle level, variations in the content of raw materials contained in the toner particles and an increase in the exposure of raw materials on the surface may occur. As a result of the non-uniformity of the toner particles, issues such as poor toner charge, conveyance failure, and decreased image quality due to background fouling may occur.

### SUMMARY

According to embodiments of the present disclosure, a toner is provided that contains toner base particles, each containing a binder resin, a release agent, and a charge control agent, and an external additive, wherein the toner base particles have an average circularity of from 0.850 to 0.950, and the external additive contains at least an inorganic particle selected from the group consisting of barium sulfate, magnesium hydroxide, and magnesium oxide, each having an average circularity of from 350 to 1,000 nm.

As another aspect of embodiments of the present disclosure, a toner accommodating unit accommodating the toner mentioned above is provided.

As another aspect of embodiments of the present disclosure, an image forming apparatus is provided that includes a latent electrostatic image bearer, a latent electrostatic image forming device to form a latent electrostatic image on the latent electrostatic image bearer, a developing device to develop the latent electrostatic image formed on the latent electrostatic image bearer with the toner of claim 1 to obtain a visible image, a transfer device to transfer the visible image onto a transfer medium, and a fixing device to fix the visible image transferred to the transfer medium.

As another aspect of embodiments of the present disclosure, an image forming method is provided that includes forming a latent electrostatic image on a latent electrostatic image bearer, developing the latent electrostatic image formed on the latent electrostatic image bearer with the toner of claim 1 to obtain a visible image, transferring the visible image formed on the latent electrostatic image bearer to a transfer medium; and fixing the visible image on the transfer medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an image forming apparatus employing a tandem system according to an embodiment of the present invention;

FIG. 2 is a partially enlarged diagram illustrating the diagram illustrated in FIG. 1; and

FIG. 3 is a diagram illustrating an example of the process cartridge as the toner accommodating unit of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present invention, a toner is provided that can form high quality images for a long time with minimal fluctuation in charges over time.

### Toner

The toner of the present disclosure contains toner base particles each containing a binder resin, a release agent, and a charge control agent, an external additive, and other optional components.

The toner base particle has an average circularity of from 0.850 to 0.950 and the external additive contains at least one type of inorganic particle selected from the group consisting of barium sulfate, magnesium hydroxide, and magnesium oxide with a particle diameter of from 350 to 1,000 nm.

The toner may be referred to as “electrophotographic toner”.

Conventional technology has the problem of degraded image quality (background fouling) due to the presence of irregularly shaped toners with low circularity, as well as the problem of degrading cleanability when attempting to enhance the level of circularity.

Therefore, the present invention is to provide a toner that can ensure sufficient cleanability and achieve good image quality with minimal background fouling.

The inventors of the present invention, in their investigation to solve the problems of the conventional technology, discovered that a toner containing toner base particles that contain a binder resin, a release agent, and a charge control agent, along with an external additive, where the average circularity of the toner base particles is between 0.850 and 0.950, and the external additive contains at least one type of inorganic particle selected from the group consisting of barium sulfate, magnesium hydroxide, and magnesium oxide, with their particle diameter between 350 nm and 1000 nm, can exhibit sufficient charging performance from the initial use through to prolonged periods, and can thus provide a toner capable of forming high-quality images over the long term. This discovery led to the completion of the present disclosure.

### Toner Base Particle

The toner base particle (hereinafter also referred to as base particle or mother particle) contains a binder resin, a release agent, and a charge control agent. The toner base particle preferably contains a colorant and optionally contains other components.

### Average Circularity of Toner Base Particle

The toner base particle has an average circularity of from 0.850 to 0.950 and preferably from 0.890 to 0.945.

Toner base particles with an average circularity of 0.950 or less can avoid producing foul images caused by a poorly cleaned surface of an image bearer or transfer belt if the toner is used in a system employing blade cleaning. Such poor cleaning performance is not an issue in the case of development or transfer with low toner coverage because the residual toner remaining after transfer is minimal. However, toner may persist and accumulate on an image bearer like a photoconductor if images are incompletely transferred due to medium feeding trouble or extremely high toner coverage, especially in color photo images. The accumulated toner could lead to background fouling on images. In addition, the toner may contaminate the charging roller for charging a member such as an image bearer in a contact manner, thereby degrading the original charging power of the roller. A toner base particle with an average circularity of 0.950 or less prevents such drawbacks.

Additionally, if the average circularity of the toner base particles is less than 0.850, transferability worsens. Although this is less likely to be a problem when the image area ratio is low, at higher image area ratios, the deteriorated transferability results in a larger amount of residual toner remaining on the photoconductor. This increase in residual toner leads to more toner being collected, which hastens the end of the toner's life.

The average circularity of the toner base particle can be measured with a measuring device such as a flow particle image analyzer (FPIA-3000, available from SYSMEX CORPORATION).

The specific procedure for obtaining the average circularity is as follows:
(1) A surfactant as a dispersion agent, preferably 0.1 to 0.5 ml of an alkylbenzenesulfonic acid salt, is added to 100 to 150 ml of water from which solid impurities have been preliminarily removed;
(2) about 0.1 to about 0.5 g of the toner base particle as a sample to be measured is added to the mixture prepared in (1);
(3) the liquid suspension in which the toner base particle is dispersed is subjected to an ultrasonic dispersion treatment for 1 to 3 minutes such that the concentration of the particles is 3,000 to 10,000 particles per microliter; and
(4) the shape of the toner base particles is measured to obtain their average circularity with the device mentioned above.

### Binder Resin

The binder resin is not particularly limited and can be suitably selected to suit to a particular application.

Specific examples include, but are not limited to, styrene, styrene-based resins (homopolymers or copolymers of styrene or styrene substitute) such as poly-α-styrene, styrene-chlorostyrene copolymers, styrene-propylene copolymers, styrene-butadiene copolymers, styrene-vinyl chloride copolymers, styrene-vinyl acetate copolymer, styrene-maleic acid copolymer, styrene-acrylic acid ester copolymer, styrene-methacrylic acid ester copolymer, styrene-α-chloroacrylic acid methyl copolymer, and styrene-acrylonitrile-acrylic acid-ester copolymers, epoxy resins, vinyl chloride resins, rosin-modified maleic acid resins, phenol resins, polyethylene resins, polypropylene resins, petroleum resins, polyurethane resins, ketone resins, ethylene-ethyl acrylate copolymers, xylene resins, and polyvinyl butyrate resins. These can be used alone or in combination.

Of these, polyester resins are preferable to achieve good low temperature fixing while keeping stability in a high temperature and humidity environment.

The method of manufacturing the binder resin mentioned above is not particularly limited and can be suitably selected to suit to a particular application. It includes bulk polymerization, solution polymerization, emulsion polymerization, and suspension polymerization.

### Polyester Resin

The polyester resin is not particularly limited and can be suitably selected to suit to a particular application. It includes a crystalline resin, an amorphous resin, and a modified polyester resin. These can be used alone or in combination.

Of these, an amorphous polyester resin is preferable obtained by allowing to react polyol with polycarboxylic acid.

Specific examples of the polyol include, but are not limited to, diols, and tri- or higher polyols.

Specific examples of diol includes, but are not limited to, glycols such as ethylene glycol, diethylene glycol, propylene glycol, triethylene glycol, and propylene glycol, etherified bisphenols such as 1,4-bis(hydroxymeth)cyclohexane and bisphenol A, an adduct of bisphenol A with alkylene (having two or three carbon atoms) oxide (average adduction mol number of from 1 to 10) such as polyoxypropylene(2,2)-2,2-bis(4-hydroxyphenyl)propane, polyoxyethylene(2,2)-2,2-bis(4-hydroxyphenyl)propane, hydrogenated bisphenol A, and an adduct of hydrogenated bisphenol A with an alkylene (having two or three carbon atoms) oxide (average adduction mol number of from 1 to 10).

Specific examples of tri- or higher alcohol include, but are not limited to, glycerin, pentaerythritol, and trimethylol propane.

These can be used alone or in combination.

Specific examples of the polycarboxylic acid include, but are not limited to, dicarboxylic acids and tri- or higher polycarboxylic acids.

Specific examples of dicarboxylic acid include, but are not limited to, adipic acid, phthalic acid, isophthalic acid, terephthalic acid, fumaric acid, maleic acid, succinic acid, and succinic acid substituted with an alkyl group with 1 to 20 carbon atoms or alkenyl group with 2 to 20 carbon atoms such as dodecenyl succinic acid and octyl succinic acid.

Specific examples of the tri- or higher carboxylic acid include, 1,2,4-benzene tricarboxylic acid (trimellitic acid), 1,2,5-benzene tricarboxylic acid, 1,2,4-cyclohexane tricarboxylic acid, 1,2,4-naphthalene tricarboxylic acid, 1,2,5-hexane tricarboxylic acid, 1,3-dicarboxyl-2-methylene carboxy propane, 1,2,7,8-octane tetracarboxylic acid, and their anhydrides.

These may be used alone or in a combination of two or more thereof.

The molecular weight of the polyester resin is not particularly limited and can be suitably selected to suit to a particular application. It is preferably within the following range.

The weight average molecular weight (Mw) of the polyester resin is preferably from 10,000 to 100,000 and more preferably from 30,000 to 50,000.

The peak top molecular weight of the polyester resin is preferably from 10,000 to 60,000 and more preferably from 10,000 to 16,000.

The molecular weight can be measured with a gel permeation chromatography (GPC).

The glass transition temperature Tg of the polyester resin is preferably from 50 to 75 degrees C. and more preferably from 60 to 72 degrees C.

A Tg of 50 degrees C. or higher enhances the toner's high temperature storage stability and durability to stress such as agitation in a developing device. In addition, toners with a Tg of 75 or lower degrees C. suitably deform when heated or pressured in fixing the toners, enhancing the low temperature fixability.

The proportion of the polyester resin is not particularly limited and can be suitably selected to suit to a particular application. The number of parts of the polyester resin is preferably from 50 to 95 parts by mass and more preferably from 60 to 90 parts by mass to 100 parts by mass of the toner base particle mentioned above.

The colorant and the release agent are suitably dispersed in a toner at 50 parts by mass or greater or the polyester resin, reducing fogging and disturbance of an image obtained with the toner. A proportion of the polyester resin of 95 parts by mass or less is advantageous to producing high quality images and demonstrating excellent low temperature fixability.

### Release Agent

The releasing is not particularly limited and can be suitably selected to suit to a particular application. Any known release agent including natural wax and synthetic wax can be suitably used. These can be used alone or in combination.

Specific examples of the natural waxes include, but are not limited to, natural waxes including: vegetable waxes such as carnauba wax, cotton wax, Japan wax, and rice wax; animal waxes such as bee wax and lanolin; mineral waxes such as ozokerite; and petroleum waxes such as paraffin, microcrystalline, and petrolatum.

Specific examples of the synthetic waxes include, but are not limited to, synthetic hydrocarbon waxes such as Fisher Tropsch wax, polyethylene, and polypropylene, aliphatic acid amide ester, ketone, and ether, 12-hydroxystearic acid amide, stearic acid amide, phthalic acid anhydride imide, and chlorinated hydrocarbons; crystalline polymer resins having a low molecular weight such as homo polymers, for example, poly-n-stearylic methacrylate and poly-n-lauryl methacrylate, and copolymers (for example, copolymers of n-stearyl acrylate-ethylmethacrylate); and crystalline polymer having a long alkyl group in the branched chain are also usable.

Of these, carnauba wax, montan wax, and oxidized rice wax are preferable.

These may be used alone or in a combination of two or more thereof. Preferably, carnauba wax is fine-crystalline with an acid value of 5 or less and a particle diameter of 1 or less μm.

Montan wax generally refers to montan-based wax refined from a mineral and is preferably fine-crystal with an acid value of from 5 to 14 mgKOH/g.

Oxidized rice wax is produced by subjecting rice bran wax to oxidization in atmosphere. Its acid value is preferably from 10 to 30.

The proportion of the release agent is not particularly limited and can be suitably selected to suit to a particular application. The number of parts of the release agent is preferably from 1 to 20 parts by mass and more preferably from 2 to 10 parts by mass to 100 parts of the toner. A release agent at one or more parts by mass prevents hot offset resistance and low temperature fixability from lowering. A release agent at 20 or less parts by mass prevents high temperature storage stability from lowering and reduces the chance of fogging in an image obtained.

### Charge Control Agent

The charge control agent is not particularly limited and can be suitably selected to suit to a particular application. Examples include, but are not limited to, nigrosine dye, metal complex dye (metal azo dye), and salicylic metal complex. These can be used alone or in combination.

Of these, tri- or higher metal complex that can take a six coordination is preferable. The metal includes, but is not limited to Al, Fe, Cr, and Zr.

Of these, a metal complex taking Fe as the center metal, which is free of toxicity, is preferable.

Specifically, azo iron dye represented by the following Chemical Structure 1 is preferable.

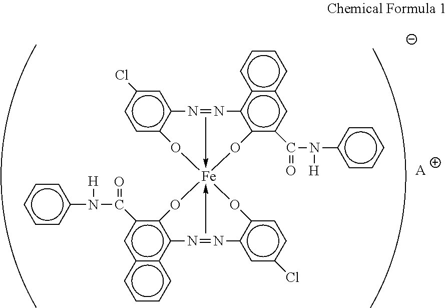

In the Chemical Structure 1, A+ represents an ammonium ion.

The azo iron dye of the Chemical Structure 1 can be procured. One of the products is T-77, available from HODOGAYA CHEMICAL CO., LTD.

The amount of the charge control agent is preferably from 0.5 to 3.0 parts by mass and more preferably from 0.5 to 2.0 parts by mass to 100 parts by mass of the binder resin.

A charge control agent at or above 0.5 parts by mass exhibits effective charge control properties. When used at or above 3.0 parts by mass, the charge control agent reduces chipping and cracking of toner particles, blade adhesion, filming, and deterioration of image quality due to poor charging or supply, as well as background fouling.

### Colorant

The colorant is not particularly limited and can be suitably selected to suit to a particular application.

Specific examples include, but are not limited to, carbon black, lamp black, iron black, aniline blue, phthalocyanine blue, phthalocyanine green, Hanza Yellow G, Rhodamine 6C Lake, Calco Oil Blue, Chrome Yellow, quinacridone, benzidine yellow, rose bengal, and triallyl methane-based dye. These can be used alone or in combination.

The toner of the present disclosure containing the colorant can be used as black toner or full color toner.

The proportion of the colorant is not particularly limited and can be suitably selected to suit to a particular application. The number of parts of the colorant is preferably from 1 to 35 parts by mass and more preferably from 3 to 20 parts by mass to 100 parts by mass of the toner mentioned above.

### External Additive

The external additive contains at least one type of inorganic particle selected from the group consisting of barium sulfate, magnesium hydroxide, and magnesium oxide, with their particle diameter between 350 nm and 1000 nm, and other optional additives.

### Inorganic Particle

The inorganic particle is selected from barium sulfate, magnesium hydroxide, and magnesium oxide. All of these materials exhibit positive charge characteristics, among which barium sulfate has the highest charging capacity, including under varying environmental conditions.

The average particle diameter of the inorganic particles is between 350 nm and 1000 nm, with a preferred range of 500 nm to 800 nm.

If the average particle diameter is smaller than 350 nm, the particles may become embedded in the toner surface, losing the opportunity to acquire charge when barium sulfate detaches from the surface of the toner base particles over time, leading to a decrease in charge.

If the average particle size is larger than 1,000 nm, it reduces the opportunity for frictional charging between toner base particles, which leads to a decrease in charge.

The average particle diameter of the inorganic particle can be measured utilizing a known method.

Specifically, measurements of the inorganic particles or the toner containing these particles are conducted using a Scanning Electron Microscope SU8200 series (available from Hitachi High-Technologies Corporation). The external additive particles in an obtained image are recognized by binarization with an image processing software called “A-zou kun”, created by Asahi Kasei Engineering Corporation. Then the circularity, equivalent circle diameter, and particle area of the particle are calculated. The obtained values are determined as those derived from the circular areas. The equivalent circle diameter is obtained as the diameter calculated from the obtained values. In the case of measuring the inorganic particles dispersed on a substrate, and in the case of measuring the surface of the toner, the measuring sites are not particularly determined; it is, however, necessary to examine at least three arbitrary fields of view, calculate the equivalent circle diameter of approximately 100 particles, and determine the average of these values as the average particle diameter.

### Hydrophobized Polymethylsilsesquioxane Particle

Polymethylsilsesquioxane is a polymer of methyl trimethoxysilane. This polymer is a silicone resin polymerized by cross-linking methyl trimethoxysilane in a three-dimensional network manner from a chemical structural point of view. The silicone resin is a spherical fine particle. Therefore, polymethylsilsesquioxane is referred to as “a polymethylsilsesquioxane particle”.

The hydrophobized polymethylsilsesquioxane particle can be obtained by subjecting polymethylsilsesquioxane particle to hydrophobization.

The average particle diameter of the polymethylsilsesquioxane particles is between 0.050 μm and 0.150 μm, and more preferably between 0.100 μm and 0.135 μm.

An average particle diameter greater than 0.150 μm weakens the attachment of the polymethylsilsesquioxane particles to the surface and results in rolling and detachment from the toner's surface.

The average particle diameter of the polymethylsilsesquioxane particle can be measured utilizing a known method.

Specifically, the polymethylsilsesquioxane particle or a toner with the polymethylsilsesquiox particle externally attached thereto as an external additive is subjected to measuring with a scanning electron microscope (SU8200 series, available from Hitachi High-Technologies Corporation). The external additive particles in an obtained image are recognized by binarization with an image processing software called “A-zou kun”, created by Asahi Kasei Engineering Corporation. Then the circularity, equivalent circle diameter, and particle area of the particle are calculated. The obtained values are determined as those derived from the circular areas. The equivalent circle diameter is obtained as the diameter calculated from the obtained values. In the case of measuring the polymethylsilsesquioxane particles dispersed on a substrate, and in the case of measuring the surface of the toner, the measuring sites are not particularly determined; it is, however, necessary to examine at least three arbitrary fields of view, calculate the equivalent circle diameter of approximately 100 particles, and determine the average of these values as the average particle diameter.

### Method of Manufacturing Polymethylsilsesquioxane Particle

The polymethylsilsesquioxane particle can be manufactured by mixing and condensing a liquid hydrolyzate containing a hydrolyzate of methyl trimethoxysilane and an anionic surfactant with a precipitate containing water, a basic catalyst, and anionic surfactant.

Specific examples of the anionic surfactant include, but are not limited to, carboxylic acid-type anionic surfactants such as aliphatic monocarboxylates, polyoxyethylene alkyl ether carboxylates, and aliphatic acid oils; sulfonic acid-type anionic surfactants such as dialkyl sulfosuccinates, polyoxyethylene alkyl sulfosuccinates, alkanesulfonates, linear alkylbenzenesulfonates, branched alkylbenzenesulfonates, naphthalenesulfonate-formaldehyde condensates, and alkylnaphthalenesulfonates; sulfate ester-type anionic surfactants such as alkyl sulfates, polyoxyalkylene alkyl ether sulfates, and aliphatic acid sulfates; and phosphate ester-type anionic surfactants such as alkyl phosphates, alkyl phosphates, polyoxyethylene alkyl ether phosphates, and polyoxyethylene alkylaryl ether phosphates. Of these, sulfonic acid-type anionic surfactants and sulfate ester-type anionic surfactants are preferable.

The liquid hydrolyzate preferably furthermore contains an acid catalyst such as an organic acid and an inorganic acid.

Specific examples of the organic acid include, but are not limited to, formic acid, acetic acid, propionic acid, oxalic acid, and citric acid. Specific examples of the inorganic acid include, but are not limited to, hydrochloric acid, sulfuric acid, nitric acid, and phosphoric acid.

As condense reaction of silanol groups proceeds in mixing the liquid hydrolyzate and the precipitate, polymethylsilsesquioxane particles are formed.

The liquid dispersion of the polymethylsilsesquioxane particle obtained in this reaction is subjected to membrane separation, centrifugal and other methods to obtain polymethylsilsesquioxane particles. The polymethylsilsesquioxane particles can be hydrophobized by surface-treating with hexamethyl disilazane (HMDS) or other substances in the liquid before separation.

The hydrophobized polymethylsilsesquioxane particle can be obtained by subjecting polymethylsilsesquioxane particles to hydrophobization with a hydrophobizing agent. Examples of the hydrophobizing agent include, but are not limited to, known organic silicon compounds with an alkyl group (for example, a methyl group, an ethyl group, a propyl group, or a butyl group).

Specific examples include silazane compounds (for example, silane compounds such as methyltrimethoxysilane, dimethyldimethoxysilane, trimethylchlorosilane, and trimethylmethoxysilane, hexamethyldisilazane, and tetramethyldisilazane). These may be used alone or in a combination of two or more thereof.

Of these, organic silicon compounds with a trimethyl group such as trimethylmethoxysilane and hexamethyldisilazane are preferable. In addition, silicon oil treatment may be used.

This hydrophobizing prevents particles from agglomerating and enhances the dispersibility to Toner Base. In addition, the impact of severe environmental conditions such as high temperature and high humidity or low temperature and low humidity can be reduced, achieving stable image quality.

The proportion of the polymethylsilsesquioxane particle is preferably from 0.05 to 3 parts by mass to 100 parts by mass of the toner. A proportion of 3 parts by mass or less reduces the occurrence of filming. A proportion of 0.05 parts by mass or greater can reduce fluctuation of flowability and chargeability over a long period of time, which leads to an advantage of achieving high image quality.

### Other External Additive

The toner of the present disclosure contains inorganic particles selected from the group consisting of at least barium sulfate, magnesium hydroxide, and magnesium oxide, and can be used in combination with other external additives, allowing for the use of two or more types together.

The other external additives include, but are not limited to, flowable improvers and hydrophobizing treatment agents.

Specific examples of the flowable improvers include, but are not limited to, silicon oxide, titanium oxide, silicon carbide, aluminum oxide, barium titanate. Of these, hydrophobized silica is particularly preferable.

### Method of Manufacturing Toner

The toner can be manufactured by a method known in the art including melt-kneading toner materials, pulverizing the melt-kneaded matter obtained, classifying the pulverized matter obtained to obtain toner base particles, and externally-adding an external additive to the toner base particle obtained.

In the melt-kneading, the toner materials are mixed and the mixture obtained is charged in a melt-kneading machine for melt-kneading. The melt-kneading machine includes, but is not limited to, a single or twin screw continuous melt-kneader and a batch-melt-kneader using a roll mill. Specific examples include, but are not limited to, a KTK type twin screw extruder manufactured by Kobe Steel, Ltd., a TEM type extruder manufactured by Toshiba Machine Co., Ltd., a twin screw extruder manufactured by KCK Engineering, a PCM-type twin screw extruder, manufactured by Ikegai Corp., and a kokneader manufactured by Buss Ag.

Preferably, this melt-kneading is conducted under suitable conditions to avoid severing the molecular chain of a binder resin. Specifically, the temperature in the melt-kneading is determined according to the softening point of the binder resin. When the temperature is too high relative to the softening point, the molecular chain is likely to be severely severed. When the temperature is too low relative to the softening point, dispersion may not proceed smoothly.

In the pulverizing, the melt-kneaded matter obtained in the melt-kneading is pulverized. In this pulverizing, the melt-kneaded matter is preferably subjected to coarse pulverizing, followed by fine pulverizing. The melt-kneaded matter is pulverized by colliding with a collision board in a jet stream, colliding particles in a jet stream, or pulverizing at narrow gaps between a stator and a rotor that mechanically rotates.

In the classifying, the pulverized matter obtained in the pulverizing is classified and adjusted to have a predetermined particle diameter. The pulverized matter can be classified by removing fine particles with a device such as a cyclone, a decanter, or a centrifugal. After the pulverizing, the pulverized matter is classified in an air stream by centrifugal to manufacture toner base particles with a predetermined particle diameter.

In the externally adding, an external additive is externally added to the toner base particles obtained in the classifying. The toner base particle and external additive are mixed and stirred in a mixer. During this process, the external additive is broken down, and the resulting fragments coat the surface of the toner base particle.

### Developing Agent

The developing agent contains at least the toner and other suitably selected optional components such as carrier.

When the toner of the present disclosure is used as a developing agent, the toner can be used as a single-component developing agent or a mixture of the toner and carrier can be used as a two-component developing agent. There is no particular limitation to these developing agents. A two-component developing agent is preferable to enjoy a long working life when a developing agent is used in a higher performance printer capable of supporting the high information processing speed recently achieved.

In the case that the developing agent is a two-component developing agent containing the toner of the present disclosure and carrier, the carrier can be magnetic or non-magnetic carrier depending on the type of the two-component developing method employed.

Examples of the magnetic carrier include, but are not limited to, spinel ferrites such as magnetite and gamma ferric oxide, spinel ferrites containing one or two types of metals such as Mn, Ni, Zn, Mg, and Cu other than iron, magnetoplumbite type ferrites such as barium ferrite, and iron or alloyed metal particles with an oxidized layer on the surface.

The shape of the magnetic carrier may be granular, spherical, or needle-like.

Of these, a strongly-magnetic fine particles such as iron particles is particularly preferable to obtain highly magnetized particles. For chemical stability, spinel ferrites including magnetite and gamma ferric oxide and magnetoplumbite type ferrites such as barium ferrite are preferable.

Specific magnetoplumbite type ferrites include, but are not limited to, MFL-35S, MFL-35HS (both manufactured by Powdertech Co., Ltd.), DFC-400M, DFC-410M, and SM-350NV (all manufactured by DOWA IP Creation Co., Ltd.).

As the magnetic carrier, it is possible to use resin carrier containing magnetic fine particles such as strongly-magnetized fine particles desirably magnetized depending on its type and content.

Such resin carrier preferably has a magnetization of from 30 to 150 emu/g at 1,000 oersted.

The resin carrier can be manufactured by the following method of: spraying melt-kneaded matter of magnetized fine particles and an insulated binder resin with a spray drier; manufacturing resin carrier in which magnetized fine particles are dispersed in a condensed binder resin by allowing to react and cure monomers and prepolymers in an aqueous medium under the presence of magnetized fine particles; fixating positively or negatively-charged or conductive fine particles on a magnetic carrier's surface; coating a magnetic carrier's surface with resin; or coating a magnetic carrier's surface with resin containing positively or negatively-charged or conductive fine particles. These methods adjust the chargeability of resin carrier.

The resin for coating includes, but is not limited to, a silicone resin, acrylic resin, epoxy resin, and fluorine-containing resin. Of these, a silicone resin and an acrylic resin are preferable.

The proportion of the carrier in the two-component developing agent mentioned above is preferably from 85 to lower than 98 percent by mass. A proportion of the carrier of 85 percent by mass or greater reduces the occurrence of a defective image caused by frequent scattering of toner from a developing device. A proportion of the carrier of less than 98 percent by mass inhibits the amount of charge of a toner for electrophotographic developing from extremely increasing and the amount of the toner supplied from extremely decreasing, thereby effectively preventing decreasing the image density and producing defective images.

### Toner Accommodating Unit

The toner accommodating unit in the present disclosure contains the toner of the present disclosure in a unit capable of accommodating the toner.

Examples of the toner accommodating unit include, but are not limited to, a toner accommodating container, a developing unit, and a process cartridge.

The toner accommodating container is a vessel containing the toner.

The developing unit accommodates the toner and develops an image with the toner.

The process cartridge integrally includes at least a latent electrostatic image bearer and a developing device, accommodates toner, and is detachably attachable to an image forming apparatus. The process cartridge may further include at least one member selected from a charger, an exposure, and a cleaning device.

The toner accommodating unit of the present disclosure contains the toner of the present disclosure. The toner accommodating unit of the present disclosure is mounted onto an image forming apparatus. The image forming apparatus forms images with the toner of the present disclosure so that the images obtained have excellent low temperature fixability and high temperature storage stability.

### Image Forming Apparatus and Image Forming Method

The image forming apparatus of the present disclosure includes at least a latent electrostatic image bearer or photoreceptor, a latent electrostatic image forming device, a developing device, a transfer device, and a fixing device with other optional devices such as a cleaner, a discharging device, a recycling device, and a control device.

The image forming method of the present disclosure includes forming a latent electrostatic image on a latent electrostatic image bearer, developing the latent electrostatic image, transferring the developed image, fixing the transferred image, and optionally cleaning the latent electrostatic image bearer, discharging the latent electrostatic image bearer, recycling, and controlling.

The image forming apparatus of the present disclosure suitably executes the image forming method of the present disclosure. In the forming, the latent electrostatic image is formed with the latent electrostatic image forming device. The developing is conducted with the developing device. The transferring is conducted with the transfer device. The fixing is conducted with the fixing device. The other optional processes are conducted with the corresponding optional devices.

### Latent Electrostatic Image Forming Step and Latent Electrostatic Image Forming Device

In the forming a latent electrostatic image, a latent electrostatic image is formed on a latent electrostatic image bearer.

The latent electrostatic image forming device forms a latent electrostatic image on the latent electrostatic image bearer.

There is no specific limitation to the latent electrostatic image bearer (also referred to as electrophotographic insulator, photoconductor, or photoreceptor) with regard to factors such as material, form, structure, and size and a suitable latent electrostatic image bearer can be selected among known bearers. A latent electrostatic image bearer with a drum-like form is preferable. From a material point of view, an inorganic photoconductor made of amorphous silicone or selenium and an organic photoconductor (OPC) made of polysilane or phthalopolymethine are suitable.

An example of the organic photoconductor is a layered photoconductor, including layers—a charge-generating layer formed of non-metallic materials like phthalocyanines or titanyl phthalocyanines dispersed in a binder resin and a charge-transport layer formed of charge transport materials dispersed in a binder resin—stacked on a substrate such as an aluminum drum.

Another type is a single-layer photoconductor with a single-layer structure on a substrate, featuring a photosensitive layer formed of both charge-generating and charge-transport materials dispersed in a binder resin.

In the single-layer type photoconductor, it is also possible to add hole transport agents and electron transport agents as charge transport materials to the photosensitive layer.

Additionally, the option exists to include an undercoat layer between the substrate and either the charge-generating layer in the laminate photoconductor or the photosensitive layer in the single-layer photoconductor.

One way of forming a latent electrostatic image is to uniformly charge the surface of the latent electrostatic image bearer and irradiate the surface according to the image information obtained using the latent electrostatic image forming device.

The latent electrostatic image forming device includes at least a charger that uniformly charges the surface of the image bearer and an irradiator that irradiates the surface of the image bearer according to the image information obtained.

Charging is accomplished, for instance, by applying a bias to the surface of the image bearer using the charger.

The charger is not particularly limited and can be suitably selected to suit to a particular application. Specific examples include, but are not limited to, a known contact type charger that includes an electroconductive or semiconductive roller, brush, film, or a rubber blade, and a non-contact type charger using corona discharging such as corotron and scorotron.

Preferably, the charger is disposed in contact or non-contact with the latent electrostatic image bearer and applies a direct voltage and an alternating voltage superimposed thereon to the surface of the image bearer. Moreover, the charger is preferably a charging roller disposed in the proximity of the image bearer via a gap tape to avoid a direct contact with the image bearer and applies a direct voltage and an alternating voltage superimposed thereon to the surface of the image bearer.

The irradiation is conducted by, for example, irradiating the surface of the latent electrostatic image bearer with the irradiator.

There is no particular limitation to the irradiator and it can be suitably selected to suit to a particular application as long as the irradiator can irradiate the surface of an image bearer charged with a charger according to image information.

Specific examples include, but are not limited to, a photocopying optical system, a rod lens array system, a laser optical system, and a liquid crystal shutter optical system. A rear side irradiation system that irradiates the image bearer from the rear side thereof can be also employed.

### Developing Process and Developing Device

In the developing, the latent electrostatic image is developed with the toner of the present disclosure or the developing agent to render the latent electrostatic image visible.

The developing device develops the latent electrostatic image with the toner of the present disclosure or the developing agent to render the latent electrostatic image visible.

The visible image is formed by, for example, developing the latent electrostatic image with the toner of the present disclosure or the developing agent with the developing device.

The developing device is not particularly limited and can be selected from the known developing devices that can conduct development with the development agent of the present disclosure or the developing agent. For example, a developing device that includes a developing unit accommodating the toner of the present disclosure or developing agent and applies the developing agent to the latent electrostatic image in a contact or non-contact manner is suitably usable. The developing unit preferably includes the toner accommodating unit of the present disclosure that is detachably attached to the developing unit.

The developing unit employs a dry or wet developing method. It can take a monochrome developing unit or a full color developing unit. One of the developing units includes a stirrer that charges the toner or the developing agent by abrading and stirring and a rotatable magnet roller.

In the developing unit, for example, the toner and the carrier are mixed and stirred to triboelectrically charge the toner due to the friction therebetween. The toner is held on the surface of the rotating magnet roller, forming a magnet brush like a filament. Since the magnet roller is provided near the latent electrostatic image bearing member, some of the toner forming the magnet brush on the magnet roller's surface is electrically attracted to the surface of the latent electrostatic image bearing member. As a result, the latent electrostatic image is developed with the toner and rendered visible as a toner image on the surface of the latent electrostatic image bearer. It is preferable to apply an alternating electric field to move the toner to the surface of the latent electrostatic image bearer.

### Transfer Process and Transfer Device

In the transferring, the visible image is transferred to a recording medium.

The transfer device transfers the visible image to a printing medium.

In the transferring mentioned above, the visible image mentioned above is transferred to a printing medium. Preferably, the visible image is primarily transferred to an intermediate transfer member and thereafter secondarily transferred to the printing medium. It is more preferable that, with a two-color toner, preferably a full color toner, the visible image is primarily transferred to an intermediate transfer member to form a complex transfer image and the complex transfer image is thereafter secondarily transferred to the printing medium.

The transferring is conducted by, for example, charging the latent electrostatic image bearer with a transfer charger of the transfer device. The transfer device preferably includes a primary transfer device for transferring visible images to an intermediate transfer body to form a complex transfer image and a secondary transfer device for transferring the complex transfer image to a printing medium.

The transfer device (the primary transfer device and the secondary transfer device) preferably includes at least a transfer unit that peel-off charges the visible image formed on the latent electrostatic image bearer toward the transfer medium. One or more transfer devices can be provided. Specific examples of the transfer unit include, but are not limited to, a corona transfer unit using corona discharging, a transfer belt, a transfer belt, a transfer roller, a pressure transfer roller and an adhesive transfer device.

The intermediate transfer body is not particularly limited and can be suitably selected from the known transfer members including an intermediate transfer belt.

The transfer member is not particularly limited and can be suitably selected from the known printing media, typically printing paper.

### Fixing Process and Fixing Device

In the fixing, the visible image transferred to a printing medium is fixed thereon.

The fixing device fixes the visible image transferred to the printing medium.

Fixing can be conducted every time each color toner image is transferred to a printing medium. Alternatively, fixing can be conducted for a multi-color superimposed toner image.

There is no specific limit to the fixing device and it can be suitably selected to suit to a particular application. Using a known device that applies heating and pressure is preferable. The fixing device includes: a combination of a heating roller and a pressure roller; a combination of a heating roller, a pressure roller, and an endless belt; and a fixing device including a heating member equipped with a heat-generating member, film in contact with the heating member, and a pressing member pressed against the heating member via the film, which fixes a non-fixed image with heat and pressure when a printing substrate with the non-fixed image thereon passes through between the film and the pressing member.

The heating temperature at the fixing device is preferably from 80 to 200 degrees C.

In the present disclosure, for example, any known optical fixing device can be used in addition to or in place of the fixing device and the fixing depending on a particular application.

### Other Processes and Other Devices

In the discharging step, a discharging bias is applied to the latent electrostatic image bearer by a discharging device.

The discharging device is not particularly limited as long as it can apply a discharging bias to the latent electrostatic image bearer. It can be selected among the known discharging devices. One example is a discharging lamp.

In the cleaning, the toner remaining on the surface of the latent electrostatic image bearer is removed, which can be suitably conducted by a cleaner.

As the cleaner, any known cleaner that can remove the toner remaining on the surface of the latent electrostatic image bearer is suitable. For example, a magnetic brush cleaner, an electrostatic brush cleaner, a magnetic roller cleaner, a blade cleaner, a brush cleaner, and a web cleaner are preferable.

In the recycling, the toner removed in the cleaning mentioned above is returned to the developing device for recycle use. This recycling can be suitably conducted with a recycling device.

There is no specific limit to the recycling device and any known conveying device, etc., can be used.

The controlling controls the processes mentioned above and can be suitably conducted with a controlling device.

The controlling device (controller) is not particularly limited and can be suitably selected to suit to a particular application as long as it can control the behavior of each device. Specific examples include, but are not limited to, a sequencer and a computer.

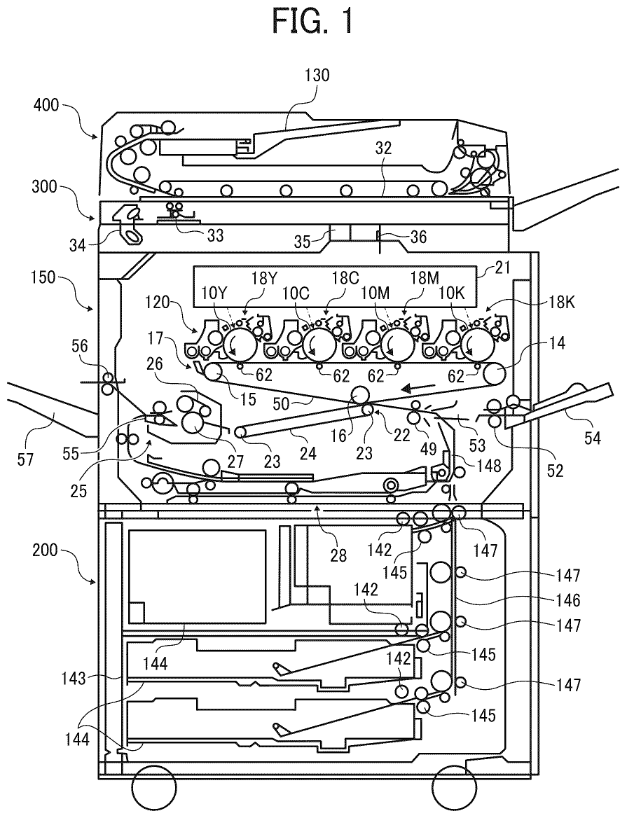

Other embodiments of the image forming method of the present disclosure are described with reference to FIG. 1.

FIG. 1 is a diagram illustrating a color image forming apparatus employing a tandem system. The image forming apparatus includes a photocopying unit 150, a sheet feeding table 200, a scanner 300, and an automatic document feeder (ADF) 400.

The photocopying unit 150 of the image forming apparatus has an intermediate transfer member 50 with an endless belt disposed at the center thereof.

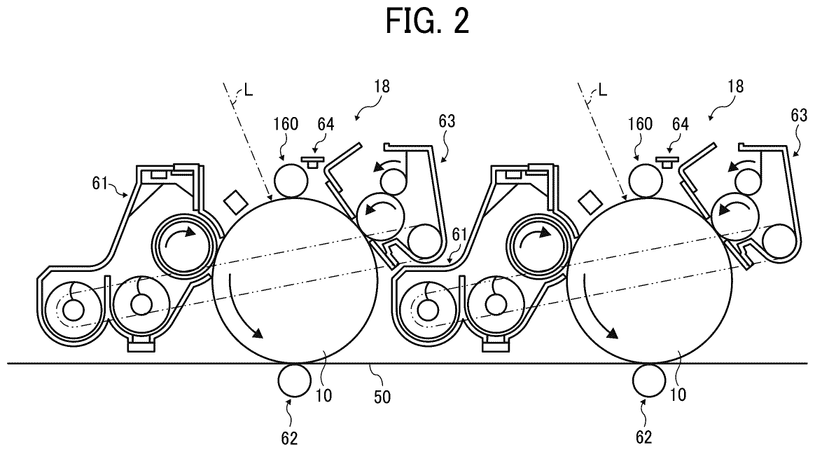

The intermediate transfer member 50 is stretched over support rollers 14, 15 and 16 and rotatable clockwise in FIG. 2. An intermediate transfer member cleaner 17 is disposed around the support roller 15 to remove residual toner on the intermediate transfer member 50. An image forming device 120 with four image forming units 18 of yellow, cyan, magenta, and black is disposed along the intermediate transfer member 50 stretched over the support rollers 14 and 15. In addition, an irradiator 21 is disposed near the image forming device 120. The secondary transfer device 22 is disposed facing the image forming device 120 with the intermediate transfer member 50 between. In the secondary transfer device 22, a secondary transfer belt 24 having an endless form is stretched over a pair of rollers 23. A transfer medium transferred onto the secondary transfer belt 24 can be brought into contact with the intermediate transfer member 50. A fixing device 25 is disposed near the secondary transfer device 22. The fixing device 25 includes a fixing belt 26 having an endless form and a pressure roller 27 pressed against the fixing belt 26.

In addition, if the image forming apparatus 120 is a tandem image forming apparatus, a sheet reverse device 28 for forming images on both sides of the transfer medium by reversing the transfer medium is disposed near the secondary transfer device 22 and the fixing device 25.

Next, how a full color image is formed with the image forming device 120 is described. First, an original is set on a document table 130 in the automatic document feeder 400. Alternatively, the automatic document feeder 400 is opened to set an original on a contact glass 32 for the scanner 300, and then the automatic document feeder 400 is closed.

When the start button is pressed, the scanner 300 is immediately driven to scan the original on the contact glass 32 with a first scanning unit 33 and a second scanning unit 34 in the case where the original is set on the contact glass 32.

On the other hand, the scanner 300 is driven after the original is moved to the contact glass 32 in the case in which the original is set on the automatic document feeder 400. Then the original is irradiated with light from the first scanning unit 33. The reflection light from the original is redirected at the mirror of the second scanning unit 34. The redirected light is received at a reading sensor 36 via an imaging forming lens 35 to read the color original to obtain image data information for black, yellow, magenta, and cyan. Each image datum is transmitted to each image forming unit 18 in the image forming device 120 to form each visible image of black, yellow, magenta, and cyan.

Each image datum for black, yellow, magenta, and cyan is transmitted to each image forming unit 18 (image forming units for black, yellow, magenta, and cyan) in the image forming device 120 employing a tandem system to form each color toner image of black, yellow, magenta, and cyan at each image forming unit 18.

As illustrated in FIG. 2, each image forming unit 18 (image forming units for black, yellow, magenta and cyan) in the image forming device 120 includes a latent electrostatic image bearer 10 (a latent electrostatic image bearer 10K for black, a latent electrostatic image bearer 10Y for yellow, a latent electrostatic image bearer 10M for magenta, and a latent electrostatic image bearer 10C for cyan), a charger 160 that uniformly charges the latent electrostatic image bearer 10, an irradiator that irradiates the latent electrostatic image bearer 10 with beams of light L according to each color image datum to form a latent electrostatic image corresponding to each color image on the latent electrostatic image bearer 10, a developing unit 61 that forms a toner image with each color toner by developing each latent electrostatic image with each color toner (black toner, yellow toner, magenta toner, and cyan toner), a transfer charger 62 that transfers the toner image to the intermediate transfer member 50, a cleaner 63, and a discharging device 64. Therefore, each single color image (black image, yellow image, magenta image, and cyan image) can be formed based on each color image datum. The black image, the yellow image, the magenta image, and the cyan image formed on the latent electrostatic image bearer 10K for black, the latent electrostatic image bearer 10Y for yellow, the latent electrostatic image bearer 10M for magenta, and the latent electrostatic image bearer 10C for cyan, respectively, are primarily transferred sequentially to the intermediate transfer member 50 rotated by the support rollers 14, 15, and 16. Then the black image, the yellow image, the magenta image, and the cyan image are superimposed on the intermediate transfer member 50 to form a synthetic color composite image (color transfer image).

In the sheet feeding table 200, one of the sheet feeding rollers 142 is selectively rotated to bring up printing media (sheets) from one of multiple sheet cassettes 144 stacked in a sheet bank 143. A separating roller 145 separates the printing media one by one to feed it to a sheet path 146. Transfer rollers 147 transfer and guide the printing medium to a sheet path 148 in the photocopying unit 150 of the image forming apparatus 100. Then the printing medium is held at a registration roller 49. Alternatively, a sheet feeding roller 142 is rotated to bring up the printing media (sheets) on a bypass tray 54. The printing media are separated one by one with a separating roller 145, conveyed to a manual sheet path 53, and also halted at the registration roller 49. The registration roller 49 is generally grounded but a bias can be applied thereto to remove paper dust on the printing medium. The registration roller 49 is rotated in synchronization with the overlapped color composite image (color transfer image) on the intermediate transfer member 50 to feed the printing medium (sheet) between the intermediate transfer member 50 and the secondary transfer device 22. The overlapped color composite image is secondarily transferred to the printing medium (sheet) to form a color image thereon. The residual toner remaining on the intermediate transfer member 50 after the image transfer is removed with the intermediate transfer member cleaner 17.

The printing medium (sheet) with transferred color image thereon is conveyed to the secondary transfer device 22 and then sent out to the fixing device 25. The fixing device 25 fixes the overlapped color composite image on the printing medium with heat and pressure. Thereafter, the printing medium is switched with a switching claw 55, then ejected outside with an ejection roller 56, and stacked on an ejection tray 57. Alternatively, the printing medium is switched with a switching claw 55, reversed with the sheet reverse device 28, and guided again to the transfer position. Then an image is formed on the reverse side. Thereafter, the printing medium is ejected with the ejection roller 56 and stacked on the ejection tray 57.

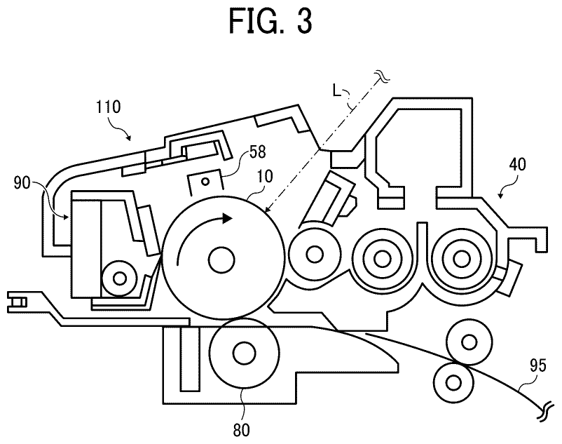

One embodiment of the process cartridge of the present disclosure is illustrated in FIG. 3. The process cartridge 110 of the present embodiment includes the latent electrostatic image bearer 10 inside, as illustrated in FIG. 3. The latent electrostatic image bearer 10 includes a charger 58 as a charging device, a developer 40 as a developing device, a cleaner 90 as a cleaning device, and other optional devices. The latent electrostatic image bearer 10 is irradiated with beams of light L and a printing medium 95 is fed into the process cartridge 110.

The latent electrostatic image bearer 10 can be the same as that of the latent electrostatic image bearer in an image forming apparatus. Any known charging member is used as the charger 58.

In the image forming process by the process cartridge 110 illustrated in FIG. 3, the latent electrostatic image bearer 10 undergoes charging by the charger 58 and exposure to the beams of light L by the irradiator while rotating in the direction indicated by an arrow, resulting in the formation of an electrostatic latent image corresponding to the exposed image on its surface.

This latent electrostatic image is developed with toner by the developer 40. The toner image obtained is transferred by the transfer roller 80 to the printing medium 95 and printed out. The surface of the latent electrostatic image bearer 10 undergoes cleaning via the cleaner 90 and discharge through a discharging device, and the process cartridge 110 is then ready for the next image formation.

According to the image forming apparatus and image forming method of the present disclosure, since the toner of the present disclosure, which can form high-quality images over the long term with little change in charge over time, is used, it is possible to provide high-quality images over the long term.

According to the image forming apparatus and image forming method of the present disclosure, since the toner of the present disclosure, which exhibits sufficient charging performance from the beginning through the passage of time, is used, it is possible to provide high-quality images over the long term.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The present disclosure is described in detail with reference to Examples but are not limited thereto. In Examples, part means part by mass unless otherwise specified.

### Manufacturing Example of Polyester Resin 1

The acid components and alcohol components shown in Table 1 were charged in a 1 L four-necked flask equipped with a thermometer, a stirrer, a condenser, and a nitrogen gas introducing tube. The flask was set on a mantle heater and nitrogen gas was introduced into the flask through the nitrogen gas introducing tube. The temperature in the flask was raised while the inert gas atmosphere was kept inside the flask. Subsequently, 0.05 g of dibutyltin oxide was added to allow reaction at 200 degrees C. Polyester Resin 1 was thus obtained.

The properties of the Polyester Resin 1 are shown in Table 1. In Table 1, the polycarboxylic acid component and the polyol component are represented in parts by mass. Mw refers to mass average molecular mass and the value of the peak top molecular weight means the molecular weight at the main peak value.

### Manufacturing Example of Polyester Resin 2

Polyester Resin 2 was obtained in the same manner as in Manufacturing Example of Polyester Resin 1 except that the type and the content in parts by mass of the polycarboxylic acid component and polyol component were changed as shown in Table 1. The properties of the Polyester Resin 2 are shown in Table 1.

TABLE 1

| Component | | Polyester resin No. | |
|---|---|---|---|
| category | Monomer | 1 | 2 |
| Acid | Terephthalic acid | 25 | 20 |
| component | Fumaric acid | 30 | — |
| | Trimellitic acid | — | 30 |
| Alcohol | Bisphenol A (2,2) propylene oxide | 25 | 15 |
| component | Bisphenol A (2,2) ethylene oxide | 20 | 35 |
| Property | Mw | 36000 | 40000 |
| | Peak top molecular weight | 13000 | 18000 |
| | Tg | 68 | 69 |

### Example 1

### Manufacturing of Toner Base A

The mixture of the following recipe was stirred and mixed with a Henschel Mixer (FM20B, available from Mitsui Miike Chemical Engineering Machinery) at 3,000 rotation per minute (rpm) for five minutes, followed by melt-kneading with a twin screw extruder (TEM-18SS, available from Toshiba Machine) at 600 rpm and a barrel temperature of from 100 to 160 degrees C. The kneaded matter obtained was subjected to rolling with a roller to have an average thickness of 1.7 mm, followed by cooling down to room temperature. The rolled matter was pulverized and classified with a Jet Mill (IDS-2, available from Nippon Pneumatic Mfg. Co., Ltd.) and a rotor classifier (100TTSP, available from Hosokawa Micron Corporation) to obtain Toner Base A with a volume average particle diameter of 7.5 μm and an average circularity of 0.935.

Composition

| | | |
|---|---|---|
| Polyester Resin 1: | 50 | parts |
| Polyester Resin 2: | 50 | parts |
| Carnauba wax WA05TS (available | 3 | parts |
| from TOA KASEI CO., LTD.): | | |
| Carbon black (MOGUL L, available | 10 | parts |
| from Cabot Corporation): | | |
| Metal azo dye (T-77, available | 1.8 | parts |
| from HODOGAYA CHEMICAL CO., LTD.): | | |

### Measuring of Average Circularity of Toner Base

The average circularity of Toner Base was measured in the following manner.

The specific procedure for obtaining the average circularity is as follows: 0.1 mL of an alkylbenzenesulfonic acid salt was added as a surfactant to 100 mL of water in a container from which solid impurities was preliminarily removed; 0.08 g of the toner base particles as the measuring sample. The liquid suspension in which the toner base particles were dispersed was subjected to ultrasonic dispersion for one minute twice to achieve a concentration of the particles of from 3,000 to 10,000 particles per microliter; and the shape of the toner base particles were measured to obtain their circularity using the measuring method mentioned above.

### Manufacturing of Toner

For 100 parts of Toner Base A, 1 part of hydrophobic silica treated with hexamethyldisilazane (HMDZ treatment) with an average particle size of 12 nm (RX200, available from Nippon Aerosil Co., Ltd.), 1 part of hydrophobic silica treated with silicone oil with an average particle size of 30 nm (NY50L, available from Nippon Aerosil Co., Ltd.), 1 part of barium sulfate with an average particle size of 600 nm (Baria Ace B-55, available from Sakai Chemical Industry Co., Ltd.), and 0.5 parts of hydrophobized polymethylsilsesquioxane particles with an average particle size of 0.05 μm (SANSIL® MP-01, available from Tokuyama Corporation) were added, followed by mixing with a Henschel mixer to obtain Toner 1 of Example 1.

### Manufacturing of Carrier 1

The mixture of the following composition was dispersed with a Homomixer for 10 minutes to prepare a liquid resin for forming a resin layer.

Composition

| | | |
|---|---|---|
| Liquid silicone resin: | 2,100 | parts |
| Toluene: | 6,100 | parts |
| Aminosilane: | 30 | parts |
| Carbon Black: | 30 | parts |

The liquid resin was applied in an atmosphere at 60 degrees C. with a fluidized bed coater to the surface of ferrite particles (DFC-400M, available from DOWA IP Creation Co., Ltd.) with a weight average particle diameter of 35 μm as the carrier core material followed by drying to achieve a thickness of 0.50 μm.

The resulting carrier was then baked in an electric furnace at 180 degrees C. for two hours. After cooling down, the substance was sifted through a sieve with a 100 μm mesh to obtain Carrier 1.

### Manufacturing of Two Component Developing Agent

Toner 1 and Carrier 1 were uniformly mixed and charged with a TURBULA® mixer, available from Willy A. Bachofen (WAB) AG, at 48 rpm for five minutes to manufacture Developing Agent 1 of Example 1 as a two-component developing agent.

The toner-to-carrier mixing ratio was adjusted to match the initial 4 percent by mass toner concentration of the developing agent in the evaluation machine.

### Example 2

Toner 2 and Developing Agent 2 of Example 2 were obtained in the same manner as in Example 1 except that the hydrophobized polymethylsilsesquioxane particles with an average particle diameter of 0.05 μm were changed to 1.5 parts of hydrophobized polymethylsilsesquioxane particles (SANSIL® MP-01, available from Tokuyama Corporation) with an average particle diameter of 0.12 μm.

### Example 3

Toner 3 and Developing Agent 3 of Example 3 were obtained in the same manner as in Example 2 except that the number of parts of barium sulfate was changed from 1 part to 3 parts.

### Example 4

Toner 4 and Developing Agent 4 of Comparative Example 1 were obtained in the same manner as in Example 1 except that the polymethylsilsesquioxane particles were not added.

### Example 5

Toner 5 and Developing Agent 5 of Example 5 were obtained in the same manner as in Example 1 except that the hydrophobized polymethylsilsesquioxane particles with an average particle diameter of 0.05 μm were changed to 1.5 parts of hydrophobized polymethylsilsesquioxane particles (SANSIL® MP-01, available from Tokuyama Corporation) with an average particle diameter of 0.20 μm.

### Example 6

Toner 6 and Developing Agent 6 of Example 2 were obtained in the same manner as in Example 2 except that barium sulfate was replaced with 1.5 parts of magnesium hydroxide with an average particle size of 700 nm (available from Sakai Chemical Industry Co., Ltd.).

### Example 7

Toner 7 and Developing Agent 7 of Example 7 were obtained in the same manner as in Example 2 except that barium sulfate was replaced with 1.5 parts of magnesium oxide with an average particle size of 600 nm (CF6, available from Tateho Chemical Industries Co., Ltd.).

### Example 8

Toner 8 and Developing Agent 8 of Example 8 were obtained in the same manner as in Example 2 except that the Toner Base A was changed to the Toner Base B prepared in the following manner.

### Manufacturing of Toner Base B

Toner Base B was obtained in the same manner as in Manufacturing Mother Toner A except that carnauba wax was changed to rice wax (TOWAX-3F16, available from TOA KASEI CO., LTD.). The Toner Base B had an average circularity of 0.920.

### Comparative Example 1

Toner 9 and Developing Agent 9 of Comparative Example 1 were obtained in the same manner as in Example 2 except that barium sulfate was not added.

### Comparative Example 2

Toner 10 and Developing Agent 10 of Comparative Example 2 were obtained in the same manner as in Example 2 except that barium sulfate with an average particle diameter of 600 nm was replaced with 0.3 parts of barium sulfate with an average particle size of 100 nm (available from Sakai Chemical Industry Co., Ltd.).

### Comparative Example 3

Toner 11 and Developing Agent 11 of Comparative Example 3 were obtained in the same manner as in Example 2 except that barium sulfate with an average particle diameter of 600 nm was replaced with 1 part of aluminum fine particle with an average particle size of 600 nm.

### Comparative Example 4

Toner 12 and Developing Agent 12 of Comparative Example 4 were obtained in the same manner as in Example 2 except that the Toner Base A was changed to the Toner Base C prepared in the following manner.

### Manufacturing of Toner Base C

Toner Base C was obtained in the same manner as in Manufacturing of Toner Base C except that the Jet Mill was changed to the Turbo Mill (T250, available from MATSUBO Corporation). The Toner Base C had an average circularity of 0.955.

The combinations of Toner Base and the external additives for the toners obtained in Examples 1 to 8 and Comparative Examples 1 to 4 are shown in Table 2.

### Evaluation

Toners and Developing Agents of Examples 1 to 8 and Comparative Examples 1 to 4 were subjected to the following evaluation. The evaluation results are shown in Table 3.

### Charging Stability

Charging stability was assessed by stirring the developing agent in a ball mill for one minute, then measuring the charge using a blow-off charge measuring device (TB-200 model, available from Toshiba Chemical Corporation) to obtain the initial charge amount, Q(1). Similarly, the charge amount, Q(60), was measured after the developing agent was stirred in the ball mill for 60 minutes.

The charge amount after one minute of stirring was recorded as the initial charge, while the charge amount after 60 minutes of stirring was assessed as the charge over time. Charging stability was evaluated using a value (Qst) calculated from the following formula as an index of charging stability.

$$\vert 1 - ( Q ( 60 ) / Q ( 1 ) ) \vert \times 100 = Qst \qquad Formula$$

S: Qst was less than 15
A: Qst was 15 to less than 20
B: Qst was from 20 to less than 40
C: Qst was 40 or greater

### Background Fogging

In a commercial image forming apparatus (available from Ricoh Co., Ltd.), the developing agent obtained above was loaded and humidified overnight in a high-temperature and high-humidity environment of 27 degrees C. and 80 percent humidity. During a blank paper printing, Scotch tape was applied over the entire exposed area of the photoconductor and then peeled off. The peeled tape was affixed to Ricoh Type 6000T target paper and stored. The L* value on the tape was measured using an X-rite (available from Videojet X-Rite Corporation). The evaluation criteria are as follows:

### Evaluation Criteria

S: L* was 92.0 or greater
A: L* was 91.0 to less than 92.0
B: L* was 90.0 to less than 91.0
C: L* was less than 90.0

### Image Quality

The image quality was comprehensively evaluated based on the deterioration of image quality after paper passing, specifically focusing on transfer defects and poor cleaning of the photoconductor.

Transfer defects were evaluated using various developing agents in a commercial image forming apparatus (available from Ricoh Co., Ltd.). An output image consisting of a vertical stripe image 2 cm wide on A4 landscape was printed for 1,000 sheets, followed by passing a full-page solid black image through the machine. The level of transfer defects was visually ranked to assess the transfer defects.

Additionally, for assessing poor cleaning of the photoconductor, after passing 1,000 sheets of a 2 cm wide vertical stripe image on A4 landscape, a solid black band image was developed and then halted during developing. After cleaning by the cleaning section, the toner remaining on the photoconductor was transferred to Scotch tape, which was then affixed to a blank sheet. This was measured using a spectrophotometer (X-Rite 938). For comparison, only the Scotch tape was affixed to the same blank sheet and measured with the spectrophotometer. The reflection density of the toner, tape, and blank sheet combined (ID: Image Density) was compared to the reflection density of the tape and blank sheet combined (ID).

The difference of the two was calculated to evaluate the cleaning performance of the photoconductor. A smaller difference value indicates better cleaning performance.

The image quality was evaluated according to the following evaluation criteria.

### Evaluation Criteria

A: No defective image
B: Slightly poor transfer performance resulted in reduced image density, while slightly poor cleaning performance led to image fouling. However, neither of the issues caused any practical problems.
C: Poor transfer performance decreased image density and resulted in areas of the image being absent, while poor cleaning performance led to image fouling.

TABLE 2

| | | | External additive | | |
|---|---|---|---|---|---|
| | | | Inorganic fine particle | | |
| | | | | Average | Amount |
| | Toner Base | | | particle | added |
| Example/Comparative | | Average | | diameter | (parts |
| Example No. | Type | circularity | Type | (nm) | by mass) |
| Example 1 | Toner | 0.935 | Barium sulfate | 600 | 1 |
| | Base A | | | | |
| Example 2 | Toner | | Barium sulfate | 600 | 1 |
| | Base A | | | | |
| Example 3 | Toner | | Barium sulfate | 600 | 3 |
| | Base A | | | | |
| Example 4 | Toner | | Barium sulfate | 600 | 1 |
| | Base A | | | | |
| Example 5 | Toner | | Barium sulfate | 600 | 1 |
| | Base A | | | | |
| Example 6 | Toner | | Magnesium | 700 | 1 |
| | Base A | | hydroxide | | |
| Example 7 | Toner | | Magnesium | 600 | 1 |
| | Base A | | oxide | | |
| Example 8 | Toner | 0.920 | Barium sulfate | 600 | 1 |
| | Base B | | | | |
| Comparative | Toner | 0.935 | None | — | — |
| Example 1 | Base A | | | | |
| Comparative | Toner | | Barium sulfate | 100 | 0.3 |
| Example 2 | Base A | | | | |
| Comparative | Toner | | Aluminum fine | 600 | 1 |
| Example 3 | Base A | | particle | | |
| Comparative | Toner | 0.955 | Barium sulfate | 600 | 1 |
| Example 4 | Base C | | | | |

| | | | External additive | | |
|---|---|---|---|---|---|
| | | | Polymethylsilsesquioxane | | |
| | | | | Average | Amount |
| | Toner Base | | | particle | added |
| Example/Comparative | | Average | Contained | diameter | (parts |
| Example No. | Type | circularity | Yes/No | (μm) | by mass) |
| Example 1 | Toner | 0.935 | Yes | 0.05 | 0.5 |
| | Base A | | | | |
| Example 2 | Toner | | Yes | 0.12 | 1.5 |
| | Base A | | | | |
| Example 3 | Toner | | Yes | 0.12 | 1.5 |
| | Base A | | | | |
| Example 4 | Toner | | None | — | — |
| | Base A | | | | |
| Example 5 | Toner | | Yes | 0.20 | 1.5 |
| | Base A | | | | |
| Example 6 | Toner | | Yes | 0.12 | 1.5 |
| | Base A | | | | |
| Example 7 | Toner | | Yes | 0.12 | 1.5 |
| | Base A | | | | |
| Example 8 | Toner | 0.920 | Yes | 0.12 | 1.5 |
| | Base B | | | | |
| Comparative | Toner | 0.935 | Yes | 0.12 | 1.5 |
| Example 1 | Base A | | | | |
| Comparative | Toner | | Yes | 0.12 | 1.5 |
| Example 2 | Base A | | | | |
| Comparative | Toner | | Yes | 0.12 | 1.5 |
| Example 3 | Base A | | | | |
| Comparative | Toner | 0.955 | Yes | 0.12 | 1.5 |
| Example 4 | Base C | | | | |

TABLE 3

| Example/Comparative | | Developing | Charging | Background | Image |
|---|---|---|---|---|---|
| Example No. | Toner No. | agent No. | stability | fogging | quality |
| Example 1 | 1 | 1 | A | A | A |
| Example 2 | 2 | 2 | A | S | A |
| Example 3 | 3 | 3 | A | A | A |
| Example 4 | 4 | 4 | S | B | B |
| Example 5 | 5 | 5 | B | S | A |
| Example 6 | 6 | 6 | B | B | B |
| Example 7 | 7 | 7 | B | B | B |
| Example 8 | 8 | 8 | A | S | A |
| Comparative | 9 | 9 | C | A | B |
| Example 1 | | | | | |
| Comparative | 10 | 10 | B | C | A |
| Example 2 | | | | | |
| Comparative | 11 | 11 | A | C | B |
| Example 3 | | | | | |
| Comparative | 12 | 12 | A | S | C |
| Example 4 | | | | | |

Aspects of the present disclosure are, for example, as follows.

### Aspect 1

A toner contains toner base particles, each containing a binder resin, a release agent, and a charge control agent, and an external additive, wherein the toner base particles have an average circularity of from 0.850 to 0.950, the external additive contains at least an inorganic particle selected from the group consisting of barium sulfate, magnesium hydroxide, and magnesium oxide, each having an average circularity of from 350 to 1,000 nm.

### Aspect 2

The toner according to Aspect 1 mentioned above, wherein the proportion of the inorganic particle ranges from 0.1 to 2.0 parts by mass to 100 parts by mass of the toner.

### Aspect 3

The toner according to Aspect 1 or 2 mentioned above, wherein the external additive further contains hydrophobized polymethylsilsesquioxane particles.

### Aspect 4

The toner according to Aspect 3 mentioned above, wherein the hydrophobized polymethylsilsesquioxane particles have an average particle diameter of from 0.050 to 0.150 μm.

### Aspect 5

The toner according to Aspect 3 mentioned above, wherein the proportion of the hydrophobized polymethylsilsesquioxane particles is from 0.05 to 3 parts by mass to 100 parts by mass of the toner.

### Aspect 6

A toner accommodating unit contains the toner of any one of Aspects 1 to 5 mentioned above.

### Aspect 7

An image forming apparatus includes a latent electrostatic image bearer, a latent electrostatic image forming device for forming a latent electrostatic image on the latent electrostatic image bearer, a developing device for developing the latent electrostatic image formed on the latent electrostatic image bearer with the toner of any one of Aspects 1 to 5 mentioned above to obtain a visible image, a transfer device for transferring the visible image onto a transfer medium, and a fixing device for fixing the visible image transferred to the transfer medium.

8. An image forming method includes forming a latent electrostatic image on a latent electrostatic image bearer, developing the latent electrostatic image formed on the latent electrostatic image bearer with any one of Aspects 1 to 5 mentioned above to obtain a visible image, transferring the visible image formed on the latent electrostatic image bearer to a transfer medium, and fixing the visible image on the transfer medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A toner comprising:
toner base particles, each comprising:
a binder resin;
a release agent; and
a charge control agent; and
an external additive,
wherein the toner base particles have an average circularity of from 0.850 to 0.950, and
the external additive contains at least an inorganic particle selected from the group consisting of barium sulfate, magnesium hydroxide, and magnesium oxide, each having an average circularity of from 350 to 1,000 nm.

2. The toner according to claim 1, wherein a proportion of the inorganic particle ranges from 0.1 to 2.0 parts by mass to 100 parts by mass of the toner.

3. The toner according to claim 1, wherein the external additive further comprises hydrophobized polymethylsilsesquioxane particles.

4. The toner according to claim 3, wherein the hydrophobized polymethylsilsesquioxane particles have an average particle diameter of from 0.050 to 0.150 μm.

5. The toner according to claim 3, wherein a proportion of the hydrophobized polymethylsilsesquioxane particles is from 0.05 to 3 parts by mass to 100 parts by mass of the toner.

6. A toner accommodating unit accommodating the toner of claim 1.

7. An image forming apparatus comprising:
a latent electrostatic image bearer;
a latent electrostatic image forming device to form a latent electrostatic image on the latent electrostatic image bearer;
a developing device to develop the latent electrostatic image formed on the latent electrostatic image bearer with the toner of claim 1 to obtain a visible image;
a transfer device to transfer the visible image onto a transfer medium; and
a fixing device to fix the visible image transferred to the transfer medium.

8. An image forming method comprising:
forming a latent electrostatic image on a latent electrostatic image bearer;
developing the latent electrostatic image formed on the latent electrostatic image bearer with the toner of claim 1 to obtain a visible image;
transferring the visible image formed on the latent electrostatic image bearer to a transfer medium; and
fixing the visible image on the transfer medium.
